(19) United States
(12) Patent Application Publication
(10) Pub. No.: US 2002/0122852 A1
(43) Pub. Date: Sep. 5, 2002

(54) Snack piece having increased packed density

(76) Inventors: Stephen Paul Zimmerman, Wyoming, OH (US); Charles Michael Garrison, Hamilton, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 09/851,040

(22) Filed: May 8, 2001

Related U.S. Application Data
(60) Provisional application No. 60/202,394, filed on May 8, 2000.

(51) Int. Cl. A23G 1/00

(52) U.S. Cl. 426/285

(57) ABSTRACT

The present invention relates to snack pieces having improved structural and geometric shape features that provide increased bulk density and method do make such a snack piece. More particularly, the present invention relates to snack pieces having improved structural and geometric shape features that provide increased bulk density, wherein the snack pieces are oriented in a nested arrangement.

### CROSS REFERENCE TO A RELATED PATENT

This application claims priority to co-pending and commonly-owned, U.S. Provisional Application Serial No. 60/202,394, Case 8072P, titled, “Nested Arrangement of Snack Pieces in a Plastic Package”; filed May 8, 2000 in the name of Stephen P. Zimmerman.

### FIELD OF THE INVENTION

The present invention relates to snack pieces having improved structural and geometric shape features that provide increased bulk density. More particularly, the present invention relates to snack pieces having improved structural and geometric shape features that provide increased bulk density, wherein the snack-pieces are oriented in a nested arrangement.

### BACKGROUND

The packaging of snack food products and/or farinaceous snack pieces, such as potato chips, corn chips, tortilla chips and others, generally involves placing the snack pieces into a package, such as a bag, in a randomly packed manner. The bags used are typically flow-wrap, polymer film bags. Although such bags are the most prevalent form of package for snacks, foil fiber composite cans are also sometimes used. The composite cans used are generally manufactured from a paper composite material consisting of a fiber paper layer, a foil layer, a metal bottom sealed to the side walls, a sealed top and a polymer overcap. However, the majority of these cans or canisters have very large diameters relative to the snack piece's linear width and length dimensions so as to allow random packing of the snack pieces.

Random packing of snack pieces into such bags and large volume cans produces a package having a low bulk density. Packages with low bulk density are essentially packages wherein the volume capacity of the package is much greater than the absolute volume of the snacks contained inside. In other words, the package contains much less net weight of snack pieces than could be held by the volume capacity of the package. The large volume package also permits the randomly packed snack pieces to settle along the bottom of the bag or can, creating a large outage in the package, i.e., the total volume of the package minus absolute volume of the product held within the package. The outage not only permits more oxygen and moisture into the package, thus increasing the opportunity for the snack pieces to become rancid and stale, but also creates a lower value perception to the consumer.

However, this random packing is most widely used in the packing of snack pieces because it is relatively cheap, requires less energy and is less complicated than packing snack pieces into a high density nested arrangement or packed alignment. Random packed snack piece packages require larger amounts of valuable store shelf or consumer pantry space being devoted to storage of snack pieces. Usage occasions for the end consumer are also limited due to lower portability of low bulk density snack piece packages. The packed density or bulk density of nested arrangements of snack pieces can be measured in terms of both the volumetric bulk density and linear bulk density.

Controlling net weight of the product is also very important in packaged goods such as snack pieces. The net weight is the prime indicator of the amount of goods being delivered to the end consumer and is a key measure of value. Strict laws exist to regulate accurate delivery of weight within a package. Also, net weight to package volume is a critical factor in distribution efficiency since the lower bulk density a package has the more shipping space required to ship the same amount of product.

U.S. Pat. No. 3,498,798, issued Mar. 3, 1970, to Bauer et al., discusses a plurality of thin, chip-type products, which are arranged in a stacked manner to form a grouped array. Bauer et al. discusses two types of chip-type snack products, one having a single curvature and the other having a compound curvature. The Procter and Gamble Pringles® Potato Crisp Brands use a nested arrangement of stacked potato crisps having a compound curve packaged in a foil fiber can. There are a other foil fiber cans having potato snack pieces in a stacked arrangement in which each snack piece has a single curvature.

However, just providing snack pieces with curvature does not always produce higher bulk densities. Large snack pieces and snack pieces with curvature can be especially space inefficient because they organize in such a way that they leave large void spaces between each piece. As noted in U.S. Pat. No. 4,844,919 issued to Szwerc on Jul. 4, 1989, the use of curved pieces is desirable to lower packed product bulk density. Thus, the snack piece's thickness, curvature, weight and orientation must be considered and potentially optimized to achieve densities above random packing.

An additional problem with placing snack pieces in densely nested arrangements is that certain snack pieces, such as tortilla chips, have surface features, i.e., texture bubbles or blisters located on the snack pieces' surfaces that provide the snack pieces with their crispy crunch. These surface features or blisters tend to increase the average thickness of the snack piece and thus lower the packed density of the snack piece nested arrangement. Additionally, these surface features tend to be very thin and fragile and thus susceptible to fracture. Thus, when stacking snack pieces with such features in a dense nested arrangement, a force is placed on the snack pieces to orient them in the arrangement and such force may break the features. Unlike randomly packed snacks, the upper and lower surface of each snack piece are placed in intimate contact with each other thus increasing the probability that a surface feature can be compressed. Furthermore, as each additional snack piece is placed on a vertical stack of snack pieces, it adds an incremental force onto the snack pieces below it. These incremental forces also can break the snack pieces' surface features. It is desirable to deliver the snack pieces to the consumer with as many of these surface features intact and yet be in a dense packed arrangement.

Snack chips and fluid condiments, “chip dips” or salsas are a very popular snack combination. However, fluid condiments or fluid portions of dips for topical application to snack pieces can create a very messy eating experience for consumers. One of the problems with the many current snack pieces, such as chip-type snack foods, on the market today is that the chips do not hold or contain a dip after it has been put on the chip, especially the fluid portions of the dip. In other words, most chips do not have a dip containment region or well or at least any sizeable one that can contain or hold fluid dips on the chip.

It would be advantageous to have thicker snack chips with raised surface features, such as the bubbles on the surface of tortilla chips, that would consistently hold a large amount of dip, and be capable of a high package density. Thicker chips would also be better able to resist breakage during the dipping experience due to their increased strength. Making chips thicker, however, traditionally creates a tradeoff that makes it more difficult to achieve higher package density. Thicker chips can deflect less when arranged in a stack leading to increased spacing between the chips, leading to lower linear density. Surface features such as bubbles add thickness with very little weight which further complicates the capability to achieve higher packed densities.

Inconsistency in the shape and thickness of snack pieces contributes to lower packed densities. Interference between adjacent snack pieces due to irregular sizing leads to increased space between nested pieces, subsequently leading to lower density. It is important for the snack pieces to be of a similar size and shape or sequentially stacked chips will require more volume due to occupying a larger cross sectional footprint.

As mentioned the majority of snacks are packaged in bags and a few are packaged in cans or trays. Snack pieces, especially chip-type snacks, have not generally been packaged in plastic containers with a semi-rigid or rigid wall, due to the cost of going to plastic in large size containers versus foil fiber cans and bags. Additionally, it is difficult to achieve a cost effective plastic container that has sufficient enough barrier protection to prevent a substantial amount of H₂O from entering the package. Without this water barrier, the snack pieces will become rancid and moist, loosing both their taste and texture. Additionally, snack pieces in nested arrangements have not been packaged in plastic, semi-rigid or rigid containers.

It would be desirable to have thick snack pieces that provide improved packed densities. It would be desirable to have snack pieces with optimized lipid content in nested arrangements having improved packed densities. It would be desirable to have desirable to have snack pieces with random topographical surface features in nested arrangements with improved packed densities. It would be desirable to have a package kit containing a nested arrangement of snack pieces having increased package density.

### SUMMARY OF THE INVENTION

A plurality of overlapping snack pieces includes a non-planar snack piece having a surface including random surface features extending from the surface, wherein the plurality of overlapping snack pieces have a volumetric bulk density of greater than about 8.0×10⁻⁵ g/mm³.

A plurality of overlapping snack pieces includes a non-planar snack piece having a concave curvature, wherein the plurality of overlapping snack pieces have a volumetric bulk density of greater than about 8.0×10⁻⁵ g/mm³.

A plurality of overlapping snack pieces includes a non-planar snack piece having a maximum thickness greater than about 2.5 mm, wherein the plurality of overlapping snack pieces have a volumetric bulk density of greater than about 8.0×10⁻⁵ g/mm³.

A plurality of overlapping snack pieces includes a non-planar snack piece having a concave curvature, wherein the plurality of overlapping snack pieces is placed in a package, the package having a packed volumetric bulk density greater than about 10×10⁻⁵ g/mm³ to about 35×10⁻⁵ g/mm³.

A plurality of overlapping snack pieces includes a non-planar snack piece having a surface including random surface features extending from the surface, wherein the plurality of overlapping snack pieces have a linear bulk density of greater than about 0.4 g/mm³.

A plurality of overlapping snack pieces includes a snack piece having a lipid content of less than about 23% by weight of the snack piece, wherein the plurality of overlapping snack pieces have a volumetric bulk density from about 8.0×10⁻⁵ g/mm³ to about 80×10⁻⁵ g/mm³.

A method for making a high bulk density plurality of overlapping thick snack pieces comprises the steps of controlling the radius of curvature of the chip by placing a dough piece of the snack piece adjacent to predetermined curved restraining device having a radius of curvature from 5 mm to about 500 mm; cooking the dough piece while the dough piece is restrained by the curved restraining device until the dough piece transforms into the final snack piece having a surface wherein random surface features extend from the surface; and placing the snack piece adjacent to other of the snack pieces to form the plurality of overlapping snack pieces, wherein the plurality of overlapping snack pieces having a volumetric bulk density greater than 8.0×10⁻⁵ g/mm³.

### BRIEF DESCRIPTION OF THE DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 is a perspective view of a sphere cap, as shown by shaded region, cut from a modeled sphere shown for exemplary purposes to aid in explanation of the design of the preferred embodiment of the present invention;

FIG. 2 is a perspective view of the preferred embodiment of the snack piece of the present invention;

FIG. 3 is a planar top view of the snack piece shown in FIG. 2;

FIG. 4 is a cross sectional view of the snack piece shown in FIG. 2;

FIG. 5 is a perspective view of a nested arrangement of a plurality of the snack pieces as shown in FIG. 2.

FIG. 6 is a perspective view of a nested arrangement of a plurality of the snack pieces of an alternate shape embodiment.

FIG. 7 is a perspective view of the preferred embodiment of the package of the present invention;

FIG. 8 is a top planar view of the package shown in FIG. 29;

FIG. 9 is a left side elevational view of the package shown in FIG. 29;

FIG. 10 is a right side elevational view of the package shown in FIG. 29; and

FIG. 11 is a bottom planar view of the package shown in FIG. 29.

### DETAILED DESCRIPTION

Randomly packed, as used herein, is defined as the packing of products without affirmatively orienting the product into any nested arrangement or packed alignment. The density of the packaged snack pieces can be increased by forming an arrangement of where a plurality of the snack pieces overlap such that the pieces are facing in substantially the same direction and where adjacent pieces partially to substantially cover one another. For example, the concave side of one snack piece would contact the convex side of an adjacent snack piece. A preferred embodiment is when the majority of the snack pieces substantially cover one another to form a nested arrangement. The term “nested arrangement”, as used herein, is defined as snack pieces aligned along a single nesting axis (N) that runs at a consistent angle versus face of each snack piece, through the face of each snack piece wherein the snack pieces are preferably all facing the same direction, and so that the pieces can fit within one another. Preferably, the cross sectional footprint at any point across the nested snack piece arrangement essentially matches the cross sectional footprint of an individual snack piece such that geometrically similar locations of adjacent snack pieces are positioned essentially along the same line that runs at a consistent angle versus the face of each snack at the given geometrically similar locations, through the faces of the snack pieces. Generally this line would be parallel to the nesting axis (N), or have a shape that conforms or follows the lead or contour of the nesting axis (N).

The plurality of overlapping snack pieces have a bulk volumetric density. This density is defined as the net weight of the snack pieces divided by the volume occupied by the snack pieces. These overlapping chips can be placed in a variety of arrangements. The occupied volume is dependent upon the specific shape and dimensions of the arrangement and the individual snack piece. Thus, one skilled in the art would be able to calculate this volume. In the preferred embodiment, the plurality of overlapping chips is a nested arrangement with a volumetric bulk density defined herein as the net weight of the nested arrangement of snack pieces per the absolute volume of the nested arrangement of snack pieces. Absolute volume, as used herein, is defined as the three dimensional space occupied which can be calculated, in the case of a nested arrangement with a straight linear axis, by the largest cross sectional footprint of the nested arrangement perpendicular to the nesting axis multiplied by the height of the nested arrangement. The two-dimensional cross sectional footprint forms a projected area that can be determined either by area calculations of a known geometry, a curve integrator, super imposing the actual drawn area on grid paper with predetermined area markings, or by comparing the weight of a piece of paper cut to the footprint outline to a weight of similar paper with a known area. The height of the nested arrangement is measured as the maximum distance between the first and last snack piece in the arrangement, preferably when the arrangement is oriented vertically to minimize spacing between the snack pieces. The volume for other arrangements where the nesting axis is not a straight line can be calculated by integration of a repeating unit, representative of the characteristic cross sectional volume of the resulting arrangement, along the length of the nesting axis.

The nested arrangement's linear bulk density, as used herein in, is defined as the net weight of the nested arrangement of snack pieces per the measurement of linear length of the nested arrangement. Also, the bulk density of packages can also be measured in terms of both the volumetric bulk density and linear bulk density. The package's volumetric bulk density, as used herein, is defined as the net weight of the nested arrangement of snack pieces contained within a package per the volume of the package. For irregular package shapes, the package can be filled with a known quantity of a fluid with a known specific gravity at a specified temperature to measure the volume. Alternately, the volume for deformable packages can be determined by the displaced liquid volume in a measuring container by submerging the closed package as expected to be used, into the measuring container. The actual volume will be the displaced volume of the package while closed minus the displaced volume of the open, empty package. The package's linear bulk density, as used herein, is defined as the net weight of the nested arrangement of snack pieces contained within the package per the measurement of linear length of the package. An alternate embodiment would be a package that contains multiple nested arrangements. The linear bulk density for this type of package would be calculated as the average weight of the individual nested arrangements divided by the average length of the package that correspondingly surrounds the individual nested arrangements.

Potato crisps that are currently marketed in a nested arrangement have a thickness from 0.7 mm to 1.3 mm. They can be as high as 2.1 mm to 2.4 mm if the crisps have embossed surface features such as ridges. Such a nested arrangement attains a volumetric bulk density of about 26×10⁻⁵ g/mm³ to 59×10⁻⁵ g/mm³ and a linear bulk density of about 0.5 g/mm to 1.1 g/mm. The nested arrangement of snack pieces within the foil fiber can attains a package volumetric bulk density of about 13×10⁻⁵ g/mm³ to 20×10⁻⁵ g/mm³ and a package linear bulk density of about 0.4 g/mm to 0.9 g/mm. A problem with thick nested chips is that the linear and volumetric bulk densities can be greatly reduced even for snack pieces made with a similar size, shape, and material composition. The Pringles Ridges® brand of stacked crisps made by the Procter & Gamble Co. are an embossed chip with grooves and raised ridges on one surface providing a thickness of between 2.1 mm to 2.4 mm per crisp. The packed volumetric bulk density of this product is about 17×10⁻⁵ g/mm³ compared to a packed volumetric bulk density of about 20×10⁻⁵ g/mm³ for Pringles Regular Potato Crisps even though the products have a very similar curved shape, size and fat content of about 38%. If the fat content were further lowered on the Ridges product to 28%, the packed volumetric bulk density would drop further to about 15×10⁻⁵ g/mm³. Fat usually added by frying the snack pieces adds weight, but not bulk volume to the snack pieces by filling the internal voids of the snack piece. Thus two problems emerge where it is difficult to attain increased densities with thicker snack pieces and it is difficult to make lower fat higher density nested snack piece arrangements.

### Density Optimization

The nesting axis preferably follows the contour of a straight line, but could follow the contour of an arc, circle, oval, helix or any combination thereof without changing the object of the invention. These constraints increase the bulk density of the nested arrangement and enable motion control. Preferably the snack pieces are of nominally the same size and shape and the nesting axis run perpendicularly through a geometrically similar location of each snack piece in the nested arrangement which will further increase the bulk density of the nested arrangement.

Surprisingly, it has been found during the present development that specific control of raised surface features for thicker snack pieces in combination with specific control of structural and geometrical features of the snack piece via a predictive mathematical model can yield increased densities for an arrangement of the snack pieces by reducing the spacing between the chips in the arrangement. A further feature is the control of the surface, geometric, and structural features to provide control of the spacing between chips to minimize the impact of compression forces that would otherwise damage fragile surface features, like the bubbles or blisters.

An advantage of snack pieces in a nested arrangement is a density with much less space occupied by the snack pieces. The volumetric bulk density should be between about 8.0×10⁻⁵ g/mm³ to about 80×10⁻⁵ g/mm³, preferably between about 12×10⁻⁵ g/mm³ to about 65×10⁻⁵ g/mm^{3×10}⁻⁵ g/mm^{3,}, and more preferably between about 25×10⁻⁵ g/mm³ to about 60×10⁻⁵ g/mm³, much more preferably between about 35 ×10⁻⁵ g/mm³ to about 60×10⁻⁵ g/mm³. The nested linear bulk density should be between about 0.4 g/mm to about 1.5 g/mm, preferably between about 0.5 g/mm to about 1.2 g/mm, and more preferably greater than about 0.7 g/mm to about 1.2 g/mm. The packed volumetric bulk density should be between about 10×10⁻⁵ g/mm³ to about 35×10⁻⁵g/mm³, preferably between about 14×10⁻⁵ g/mm³ to about 35×10⁻⁵/mm³, more preferably between about 18×10⁻⁵ g/mm³ to about 35×10⁻⁵g/mm^{3,}, and much more preferably between about 2.1×10⁵ g/mm³ to about 33×10⁻⁵ g/mm³. The packed linear bulk density should be between about 0.3 g/mm to about 0.85 g/mm, preferably between about 0.45 g/mm to about 0.70 g/mm, and more preferably between about 0.55 g/mm and to about 0.65 g/mm.

The practice of nesting and stacking snack pieces however, does not guarantee an increased packed density vs. other types of snack products such as chips randomly packed in bags. Several physical attributes of the snack piece can singularly or in combination yield low packed densities. The shape of the chip as defined by its curved or angular regions, individual piece weight, number of snack pieces, thickness and elasticity of the chip matrix all impact how well the individual pieces will nest together as measured by the space between individual chips.

The density of the snack chip itself can be impacted by the same factors that govern the nesting and packed bulk density properties. For example, chip thickness relates to the weight of the chip versus the volume occupied by the chip. It is important to control the density of the individual snack pieces to maintain an acceptable eating texture. The density of an individual snack piece can be readily determined by one skilled in the art by measuring the weight of the snack piece divided by its volumetric displacement in a fluid of a known specific gravity. Preferably, a number of snack pieces are measured to determine an average with a standard deviation that is less than 20% of the average and more preferably where the standard deviation is less than 10% of the average. The snack piece density should be between about 1.0×10⁻⁴ to about 17×10⁻⁴ g/cm³, preferably between about 2.0×10⁻⁴ to about 17×10⁻⁴ g/cm³, more preferably between about 2.0×10⁻⁴ to about 12×10⁻⁴ g/cm³, much more preferably between about 2.0×10⁻⁴ to about 10×10⁻⁴ g/cm³, substantially more preferred between about 2.0×10⁻⁴ to about 5.0×10⁻⁴ g/cm³, and most preferred between about 2.1×10⁻⁴ to about 3.0×10⁻⁴ g/cm³.

Typically, snack pieces for stacking are non-planar, i.e., three-dimensional, typically comprising single or a multiple of curved regions. The snack pieces can take any shape, size and form. The smallest radius of curvature present from any one part of the snack piece governs the space between nested chips and subsequent packed density.

One embodiment of the snack piece of the present invention, the snack piece includes a dip-containment well (12) and is more fully shown and described in U.S. patent application Ser. No., Case No. 8073M, titled, “An Ergonomic Snack Piece Having Improved Dip Containment”, filed May 8, 2001 in the name of Stephen P. Zimmerman and herein incorporated by reference. The shapes that more readily form containment wells can be formed by taking a cap section or segment of a three-dimensional, source shape, including but not limited to spheres, ellipsoids, elliptic paraboloids, pyramids, right angle circular cones, or elliptic cones. The source shape may have one major radius of curvature, such as for spheres, two (major and minor), such as for ellipsoids, or more, such as for more complex shapes. The range of radius of curvature is from about 5 mm to about 500 mm, preferably from about 10 mm to about 150 mm, more preferably from about 10 mm to about 90 mm, and yet more preferably from about 15 mm to about 65 mm, most preferably from about 45 mm to about 55 mm. A cap or segment is cut from this three-dimensional, source shape.

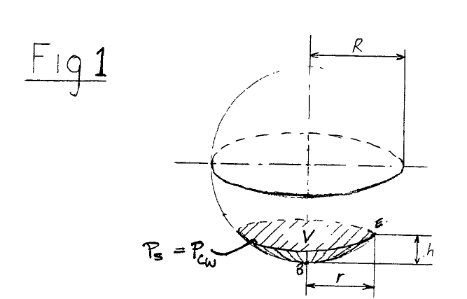

FIG. 1, for example, shows a sphere, which has been modeled, and then a sphere cap or segment has been cut from that sphere as shown in by the shaded region. When this sphere cap is cut from the sphere, it can then be formed or cut into any two-dimensional shape, such as a triangle, forming a two-dimensional shape having a three-dimensional curvature. In the preferred embodiment, the chip is a triangular-shaped sphere cap. This will be explained more fully later in the application using the preferred embodiment to exemplify the invention. Any number of two-dimensional cross sectional shapes can be cut from the source three-dimensional shape to form a variety of interesting snack shapes. These two-dimensional shapes include but are not limited to circles, ovals, ellipses, parabolas, parallelograms, trapezoids, rectangles, squares, polygons, or triangles or sections of any combination of the above.

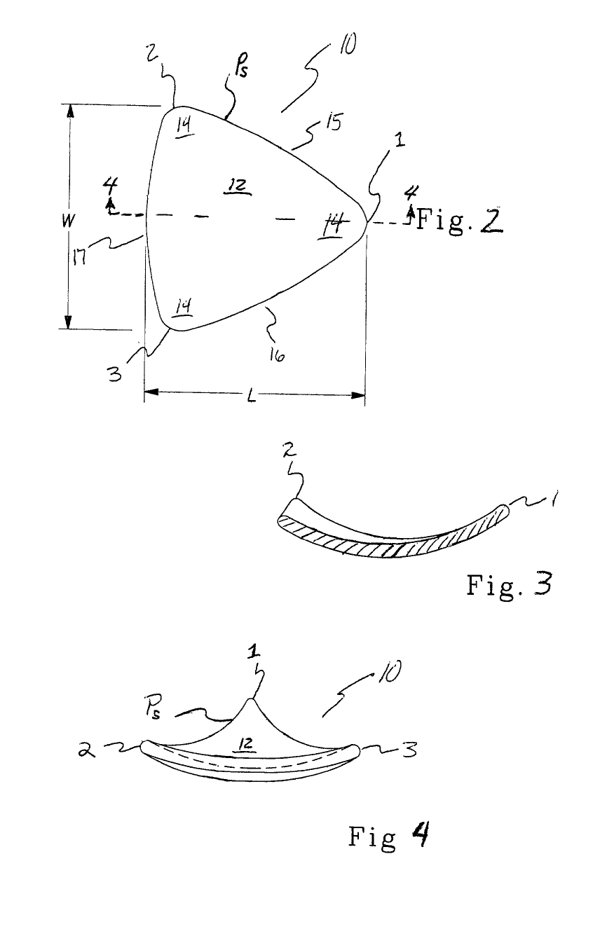

Referring to FIGS. 2 to 4, a preferred embodiment of the chip (10) is shown. Chip (10) includes a containment well (12) that contains the dip on a top surface of the chip, a grip region (14) that is beyond, and preferably above, the containment well (12) and a peripheral edge (Ps) of the chip shape. The containment well (12) prevents the dip from flowing over the chip's peripheral edge (Ps) in all linear directions when in an equilibrium state. Containment well (12) is preferably bowl-shaped or concave-curved. Also, the chip can have more than one grip region (14), preferably three grip regions (14). The grip region (14) is of sufficient size to enable comfortable finger placement. The overall size, shape and curvature of the chip provides the capability for hand held control, improved dip holding capacity and dipping motion. Chip (10) is preferably a uniform chip wherein each chip that is produced is of substantially the same size, shape and dimension. The peripheral edge (Ps) forms the outer edge of the chip and defines the two-dimensional shape of the chip. Additionally, the containment well (12) may have a perimeter (Pcw) that is defined by the containment volume of the containment well (12). Since the containment well (12) may be formed by a smooth curvature of the chip, such as a sphere cap, there may not be any noticeable edge separating the containment well (12) from the grip regions (14).

The hypothetical sphere has a radius of curvature from about 35 mm to about 90mm, preferably from about 45 mm to about 65mm and most preferably from about 50 mm to about 55 mm. A three-dimensional, triangular-shaped sphere segment is cut from the sphere segment shaded in FIG. 1 to form the preferred chip of the present invention. The triangular shape is the most preferred shape for a dipping chip since it is ergonomically easier to grasp at any of three vertices (1, 2, 3) of the triangular shape and provides multiple entry points for dip to be “scooped” onto the chip and into the containment well (12).

Length (L) of the chip at it longest location is greater than about 15 mm, preferably greater than about 30 mm, and most preferably greater than about 40mm and width (W) of the chip at it widest location is greater than about 15 mm, preferably greater than about 30 mm, and most preferably greater than about 40 mm. The aspect ratio of the width divided by the length is greater than about 0.50, preferably greater than about 0.60, more preferably greater than about 0.70, and most preferably greater than about 0.75. As shown in FIG. 2, the preferred embodiment has a length (L) from about 40 mm to about 110 mm, preferably from about 50 mm to about 80 mm, and most preferably from about 60 mm to about 65 mm and a width (W) from about 30 mm to about 110 mm, preferably from about 40 mm to about 80 mm, and most preferably from about 50 mm to about 60 mm. Sides (15, 16) of the triangle have lengths from about 40 mm to about 80 mm, preferably between about 50 mm to about 75 mm and most preferably from about 60 to about 70 mm and side (17) has a length from about 30 to about 75 mm, more preferably from about 40 mm to about 70 mm and most preferably from about 50 mm to about 60 mm.

The total height or length of the nested stack piece arrangement is also an important consideration. Shelf space in stores can be limited. The package must also be ergonomically comfortable for the consumer to handle. The total height or length of the nested snacks arranged along a linear axis is ideally less than about 305 mm, preferably between about 7 mm to about 254 mm, more preferably between about 10 mm to about 231 mm, most preferably between about 10 mm to 220 about mm. The length of a nested arrangement along a non-linear nesting axis is between about 7 to about 800 mm, preferably between about 20 to about 600 mm, more preferably between about 40 to about 500 mm.

An embodiment of the present development is a model for predicting the nested density and stack height for an arrangement of stacked snack pieces as a function of the specified parameters of the radius of curvature, snack piece thickness, individual piece weight, number of individual pieces per package unit, and elastic properties of the snack piece. The snack piece density is constrained to deliver acceptable texture. The model provides a means of designing snack piece shapes and properties to meet specific packed density or height targets or limitations. For example, snack piece parameters can be specified to maintain total nested snack piece length to less than 305 mm for a given number of snack pieces. The relationships between the snack piece size and shape parameters are highly non-linear and contain non-obvious interactions that limit predictive behavior. In the absence of a model, it is difficult to meet the many design constraints posed including sufficient packed density for economical distribution efficiency, optimizing the ratio of package to product costs, or meeting size requirements to fit within certain distribution channels such as fitting within the height of allotted shelf space. There are literally millions of combinations of product parameters with little guidance over which will be successful for a given set of applications targets or constraints.

The benefits of using such a modeling approach for an arrangement of chips nested along a straight line axis helps to illustrate the inter-relationships between chip shape design parameters and final density of the nested arrangement. The model can be readily expanded by one skilled in the art to optimize packed densities of other nesting axis shapes such as curved. The unloaded spacing or void space between two adjacent snack pieces is a function of the radius of curvature and the thickness of the snack piece. The inner radius of a curved snack is less than the outer radius due to the thickness of the snack. The difference between the outer and inner radius creates a separation between two nested snack pieces. The inner radius cannot fit around the outer radius, causing it to rest at a distance above the bottom of the lower snack piece. The separation that occurs between the snack pieces reduces the packed density.

The inner radius can be forced to deflect around the outer radius in the example above, thus reducing the separation between the snack pieces. The amount of deflection is a function of the elastic properties of the snack piece and the load applied to the arrangement of snack pieces. The load can be applied by gravity as in the case of a vertical stack of snack pieces where the total weight of snack pieces can create deflection or by applying mechanical pressure to each end of the stack to force a compression that would enable packaging within a given length, such as for horizontal tray packing.

Control of both the unloaded and loaded spacing can be used to deliver desired packed densities or total stack heights. The use and control of deflection can greatly increase the packed density. It is not unusual for unloaded snack piece spacing to be 2 to 10 times as great as that of loaded stacked snack pieces experiencing deflection. However, it is possible to induce too much deflection, which would lead to structural failure of the snack pieces. The amount of unloaded spacing minus the amount of deflection should be greater than zero to avoid breaking the snack piece surfaces via strain forces.

As mentioned previously, the unloaded spacing is a function of the radius of curvature. The use of a sphere cap shown in FIG. 1 as the source model geometry with a given radius across the base section (r) and a specified height (h) provides a good approximation of many curved shapes.

The total nested length for a given number of snack pieces can be calculated by:

Total Nested Length=(Height of the First Snack Piece)*(Number of Snack Pieces)*( Thickness+Loaded Spacing of Snack Pieces) [1]

wherein the height of the first snack piece is generally equal to (h). The loaded space between snack pieces equals (S)

S=(Unloaded Spacing between Two Adjacent Snack Pieces−Average Deflection between Snack Pieces) [2]

For the present development, the relationships between unloaded spacing (U) and shape parameters is as follows:

U=((b²/a²)*(2aδ+δ²))^{½} [3]

wherein (a) equals (r) from FIG. 1, and (b) equals (h) from FIG. 1.

The snack piece can be modeled as a beam structure under a uniform stress applied at each end of the surface to predict the deflection that occurs in a loaded state. In these circumstances, the maximum deflection that occurs is represented by

Maximum Deflection=Δ=0.002693*((W*a³)/(Modulus of Elasticity*Moment of Inertia)) [4]

wherein W equals the mass load applied to the snack pieces which is equal to the total number of snack pieces in the nested arrangement multiplied by the average snack piece weight, the major axis is for the curve present within the snack piece having the smallest major axis length. The moment of inertia (I) reflects how the snack piece shape will move as a function of applied forces, is dependent upon the shape profile and can be calculated as:

I=3a²bδ−3abδ²+bδ³+a³δ+3a²δ²−3aδ³−δ⁴ [5]

The modulus of elasticity (E) is determined empirically for a given snack piece composition. Stack height and spacing data between snack pieces from unloaded and loaded snack piece stacks are fit to equation [4] for one of the geometries specified. First, the external height of the snack piece is measured when the snack piece is resting on a stable horizontal surface in its equilibrium state. A known load is then applied to the top of the snack piece, and the change in height, which represents the deflection, is measured. The known load can be applied by placing a free weight on the surface of the snack piece. The difference between the loaded and unloaded snack piece heights represents the amount of deflection distance as a function of applied load. Rearranging equation [4] and substituting the applied load for W and the measured deflection for Δ yields

$${E}_{measured} = \frac{0.002693 * ( ( {W}_{measured} * {a}^{3} ) / Moment of Inertia ) )}{{Δ }_{measured}} \qquad [ 6 ]$$

The desired range of the modulus of elasticity will vary by the particular snack piece geometry and composition, but should be in the range from about 0.1 g/mm² to about 6.0 g/mm². A further refinement of the model can be obtained by developing a correlation of E to the amount of load applied.

Equations [3] and [4] can be substituted into equation [2] to yield

S=U−Δ [7]

Equation [7] can be substituted into equation [1] to calculate stack heights resulting from changes in the snack piece geometric or structural properties. The model provides a rapid means of testing the effects of snack piece geometry, thickness, weight, elastic properties, or number of snack pieces.

The volumetric bulk density is derived from the total mass of the nested snack pieces divided by the volume occupied by the stack. The occupied volume is calculated by multiplying the predicted total stack length [1] by the projected area of the snack piece. The volumetric bulk density (D_{V}) can be expressed as

D_{V}=total nested snack piece mass/(total stacked snack piece length)*(projected area) [8]

Similarly the linear bulk density D_{L} of the nested snack pieces can be calculated by dividing the total nested snack piece mass by the length of the arrangement of nested stack pieces [1] such as

D_{L}=total nested snack piece mass/total stacked snack piece length [9]

The weight of the snack piece and number of snack pieces in the nested arrangements are inputs to the model that can be used to determine the total load of the snack pieces. The thickness of the snack piece, modulus of elasticity, and the corresponding (r) and (h), where these are derived from the smallest specific sphere cap base that includes the shape, are inputs to this model. An alternate model that can be more accurate for specific shapes derives (r) and (h) from the largest sphere cap that can be contained within the periphery of the snack piece.

The density of the snack piece can be kept as a constraint and calculated from known geometric shapes by dividing the specified weight of the snack piece, an input to the model, by the volume of the snack piece which is equal to the surface area of the snack piece multiplied by its thickness also a model input. If the shape of the snack piece is highly irregular making a calculated volume difficult, then a correlation between measured density and size can be developed.

For this geometry the snack piece density D_{S} can be calculated by

D_{S}=(Weight of Snack Piece)/[(⅔*π*a²b)−(⅔*π*(a−δ)²(b−δ)²] [10]

where (a) is the radius of the sphere cap, (b) is the height of the sphere cap, and δ is the snack piece thickness.

Optimization of snack piece shape parameters vs. target levels of nested snack piece density and maximum stack height can be accomplished by entering the governing snack piece spacing equations into a spreadsheet optimization program such as Microsoft Excel Solver software. The algorithm for use of the model is as follows:

1. Upper and lower ranges for snack piece weight, radius (r), height (h), thickness, number of snack pieces and modulus of elasticity are provided as inputs.

2. Constraint values for chip density, volumetric bulk density or linear bulk density of the nested arrangement, total length of the nested arrangement and optionally final spacing between the chips or net weight of the nested snack piece arrangement are set.

3. The snack piece attributes are systematically varied by the optimization software.

4. The model snack piece density is calculated using equation [10]. If the snack piece density constraint is violated, then the combination of snack piece input attributes is rejected else the combination of snack piece input attributes is accepted for the interim.

5. The unloaded spacing of the snack chip is calculated using Equation [2].

6. The moment of inertia is calculated using Equation [5]

7. The deflection between the snack pieces is calculated using Equation [4]

8. The deflection is subtracted from the unloaded spacing using equation [7]. If the result is negative, the combination of snack piece input attributes is rejected since the negative result represents a geometry or structure that would fracture under the load applied. If the result is positive, the combination of snack piece input attributes is accepted for the interim. A further embellishment is that the resulting space between the chips can be constrained to yield a minimum gap post deflection of the snack pieces.

9. The length of the nested arrangement is calculated using Equation [1]. If the total nested arrangement length constraint is violated, then the combination of snack piece input attributes is rejected else the combination of snack piece input attributes is accepted for the interim.

10. The volumetric or linear nested densities are calculated using Equations [8] or [9] respectively. If the constraints for either the volumetric or linear bulk densities are met, then the combination of attributes successfully meeting the snack piece density, spacing, total nested arrangement length, and density requirements is recorded else the combination is discarded.

11. Optionally, the net weight of the nested snack piece arrangement can be checked versus any constraints set.

Snack pieces of the current development providing optimized nested densities are non-planar having at least a single curve in one direction where major radius (r) for the curve in the snack piece is preferably from about 10 mm to about 50 mm, more preferably from about 15 mm to about 40 mm, more preferably from about 20 mm to about 35 mm, and most preferably from about 25 mm to about 30 mm. The height for the snack piece (h) is about I mm to about 30 mm, preferably from about 2 mm to about 15 mm, more preferably from about 3 mm to about 12 mm, and most preferably from about 3 mm to about 7 mm. The individual snack piece weight is preferably from about 0.5 g to about 5.0 g, preferably from about 1.0 g to about 3.5 g, more preferably 2.0 g to about 4.0 g, and most preferably from about 2.0 g to about 3.0 g. The number of snack pieces is from about 7 to about 160, preferably from about 10 to about 100, more preferably from about 20 to about 80, and most preferably from about 60 to about 75. The net weight of the nested snack piece arrangement is from about 15 g to 300 g, preferably from about 25 g to about 200 g, more preferably from about 50 g to about 190 g, and most preferably from about 140 g to about 185 g.

Control of the thickness and surface topography of the snack piece is one method of delivering higher nested densities. Thicker snack pieces are often desirable for the variety of texture attributes that can be associated with increased thickness such as increased crispness or extended crunchiness. However, thicker chips can yield nested densities that are 10% to 25% lower than thinner snack pieces of an essentially similar size and shape which can greatly impact the economics of delivering the stacked chip to the final user by requiring increased amounts of processing time, packaging materials and transportation delivery vehicles to distribute the same net weight of product as compared to the thinner chips. Thicker chips have only been able to achieve higher nested densities and package net weights via higher fat contents that add weight without volume. It is often desirable to lower the fat content of snacks to provide an improved nutritional position. Improved control of the snack piece thickness and surface features, combined with control of the snack piece geometric and structural properties can deliver increased densities without resorting to increased product fat levels. The fat content of the snack piece should be from about 18% to about 40%, preferably from about 22% to about 32%, more preferably from about 24% to about 30%, and most preferably from about 25% to about 29%. Fat is defined as any lipid material, digestible, partially digestible, or non-digestible.

The chip surface should consist of randomly dispersed, raised surface features on both sides of the snack piece that are essentially disconnected where the maximum size of the raised surface feature is restricted. The presence of these raised surface features can provide the texture benefits of thicker snack pieces, but also provide an inter-nesting benefit wherein one piece is more likely to fit within another within the post deflection spacing that occurs between nested snack pieces. The presence of alternating, thinner regions within the snack piece adjacent to the raised surface features also enables the snack piece a greater amount of deflection than a snack piece having an increased uniform thickness. The increased deflection capability enables the inner radius of one snack piece to conform better around the outer radius of the adjacent snack piece.

### Surface Feature Control

Preferred embodiments of the current snack piece include raised surface features that are in the form of bubbles or blisters having an essentially round or elliptical shape. The surface features can be characterized by their maximum dimension. Generally, the shape and size of the surface features are random in nature. Large surface features will be defined as having a maximum dimension from 8.0 mm to about 12 mm, medium surface features will be defined as having a maximum dimension of about 5.0 mm to about 7.9 mm, and small surface features will be defined as having a maximum dimension of about 2.0 mm to about 4.9 mm. The amount of large surface features should occupy from about 12% to about 40% the total surface area of the snack piece, preferably from about 15% to about 35%, more preferably from about 18% to about 30%, and most preferably from about 20% to about 27%. The amount of medium surface features should occupy from about 20% to about 40% the total surface area of the snack piece, preferably from about 23% to about 36%, more preferably from about 25% to about 32%, and most preferably from about 28% to about 31%. The amount of small surface features should occupy from about 25% to about 60% the total surface area of the snack piece, preferably from about 30% to about 56%, more preferably from about 35% to about 50%, and most preferably from about 40% to about 48%.

The surface size and relevant surface features can be measured by making a clear plastic or acetate template the same size and shape of the snack piece surface. The template is marked with a measurement grid, preferably in increments of 2 mm to 5 mm for each grid line. The template is superimposed upon the surface of the snack piece and the maximum dimensions of all surface features are characterized. The surface features are visibly recognizable as bubble or blister surfaces rising above the base surface of the snack piece creating a localized elevation surrounded by the lower base regions. Preferably, the raised surface features are marked with colored pen to enable more ready measurement of their size with the template. At least 15 snack pieces should be measured.

In comparison the ridges stacked chips available on the market today (e.g. Pringles Ridges®) have surface features on only one side of the chip. Additionally, the ridging is continuous across the length of the chip, up to 60 mm to 65 mm in length, and is the predominant surface feature that lessens inter-nesting between adjacent chips. These surface features are a continuous pattern, even more particularly a repeating pattern. Deflection is also lessened by the more uniform thickness that results and increased strength in the length direction due to the increased surface area provided by the ridges. The definition of random surface features as found in the present invention do not include patterned surface features such as those found in Ridges

Several thickness measures are also excellent measures of the preferred topography of the present development. The average snack piece thickness can be characterized by successive local measurements over the surface where a digital caliper is used to take 10 random measurements of the total thickness of raised surface features where in each surface feature is measured only once and to take 10 measurements of the base snack chip surface that lie in between the raised surfaces. The caliper jaws contact the snack piece with one jaw on top of the surface feature and the other jaw contacting the underside of the opposite side of the snack piece just below the location of the surface feature. Between 5 to 10 snack pieces should be measured for thickness in this way to provide a total of between 100 to 200 data points. The average thickness can be taken across all the measurements for the base and surface features.

The average chip thickness should be less than about 5.0 mm, preferably less than about 2.5 mm, more preferably less than about 2.0 mm, and more preferably from about 1.5 mm to about 2.0 mm, and most preferably from about 1.75 mm to about 2.0 mm. The average thickness of the raised surface features alone should be from about 2.3 mm to about 3.2 mm, preferably between 2.4 mm to about 3.0 mm, and more preferably from about 2.5 mm to about 2.9 mm. The maximum thickness of the surface features should be less than about 5.5 mm, preferably less than about 5.0 mm, more preferably between 3.0 mm to about 4.7 mm and most preferably from about 3.0 mm to about 4.0 mm. The coefficient of variation (CV) around the entire snack piece thickness can be used as another indicator relating to random nature of the surface features. The (CV) is calculated by dividing the standard deviation around the chip thickness by the mean chip thickness and multiplying by 100%. The (CV) for chip thickness should be greater than 15%, preferably greater than 25%, more preferably greater than 35%, and most preferably greater than 40%. In comparison, the stacked chips currently available on the market today (e.g. Procter and Gamble Pringles®) have much more consistent thickness with (CV) levels of about 10%.

### Increased Density Package Kit

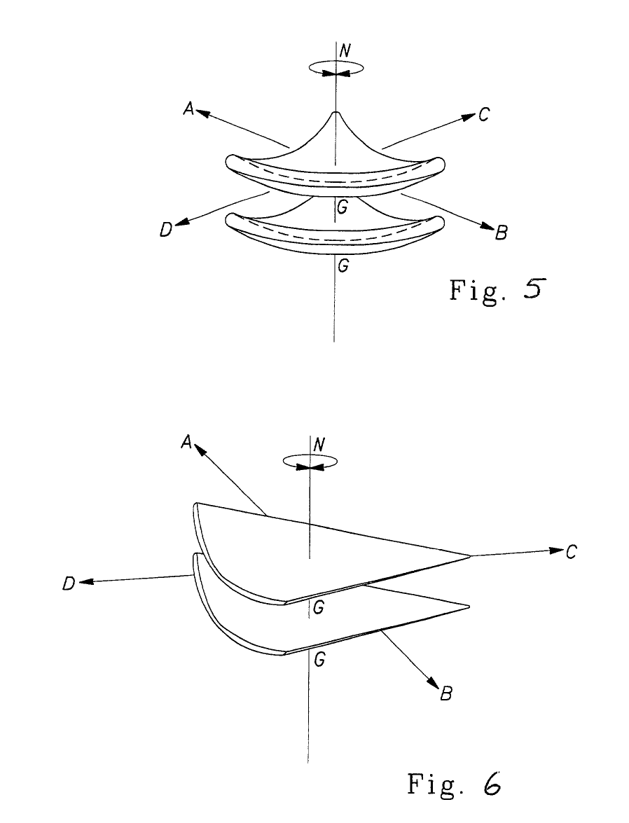

Referring to FIGS. 5 and 6, the curved shape of the present development provides motion control that facilitates retention of a nested arrangement of the snack pieces and thus maintains increased bulk density. Snack pieces that are able to de-nest will create increased void spacing between the chips, which in turn, lower the nested bulk density of the snack pieces. The increased motion control also reduces breakage that might be induced by movement of the snack piece within the package.

The interior height of the package relative to the height of a nested arrangement of snack pieces has a strong impact towards controlling motion of the snack pieces in all directions and the packed density of the package. The open space beyond the nested arrangement can allow the first pieces in the arrangement the opportunity to move, turn, and potentially become de-nested due to impact forces experienced by the package. To limit the motion of the chips in a direction parallel to the nesting axis, the amount of space between the first or last snack piece and the ends of the package, while the chips are in a nested arrangement, should be less than about 25% than the minimum dimension of the snack piece, preferably less than about 100%, more preferably less than about 83%, and most preferably less than about 53%. Preferably the snack pieces are packed in a package with a cross sectional shape matching the shape of the two-dimensional area of the snack piece to provide more motion control resistance in the direction perpendicular to and rotational about the nesting axis. Also, the amount of space between the first or last snack piece and the ends of the package, while the chips are in a nested arrangement, should be less than about 150% than minimum dimension of the snack piece, preferably less than about 110%, more preferably less than about 100%, much more preferably less than about 85% and most preferably less than about 53%.

### Consistency of Packaged Snacks

Consistency of product is helpful to delivering reliable dip holding properties and for maintaining consistent nested densities. Variation in the length, width, shape, and weight of the individual pieces can lead to a loss of nesting capability if the snack pieces do not fit together well or can lead to increased spacing between the snack pieces which will lead to a lower bulk density of the nested arrangement or package.

The coefficient of variation (“CV”) around each physical attribute of the remaining whole, non-broken snack pieces within a given package is an excellent method of characterizing the product consistency. The coefficient of variation or CV is defined as the standard deviation about a product measurement divided by the mean of the measurement taken over a sample size of 100 to 200 individual snack pieces multiplied by 100%. The CV for snack piece length at the longest distance across the snack piece should be less than 7%, preferably less than 6%, more preferably less than 5%, and much more preferably less than 4%, and most preferably less than 2%. The CV for snack piece width at the widest point of the snack piece is preferably less than about 16%, more preferably less than about 10%, much more preferably less than about 5% and most preferably less than about 2%. The CV for snack piece weight is preferably less than about 17%, more preferably less than about 15%, much more preferably less than about 10%, especially much more preferably less than about 8%, and most preferably less than about 6%. The CV for the snack piece projected area is preferably less than about 17%, preferably less than 15%, more preferably less than 12%, much more preferably less than 10%, and most preferably less than 8%.

Included in the present invention is a method to consistently provide the consumer a snack piece, preferably a tortilla chip, having a dip containment region (8). This method includes forming uniform snack pieces into the desired shapes and cooking them as shown and described herein, wherein the shape includes a dip containment region (8). This is preferably completed first. In a preferred method, the snack pieces are next treated with any type of preferred seasonings, flavored liquids or oils. The snack pieces are oriented in a nested arrangement of high bulk density, preferably a vertical stack. This nested arrangement preferably has bulk densities as shown and described herein. This step is preferably completed after the treating step. This nested arrangement is then placed into a container having a semi-rigid or rigid side wall. Preferably the container has one continuous side wall and more preferably is manufactured from plastic. In the most preferred embodiment the container is a multiple layer plastic container as set forth below. The containers are preferably then packaged into cartons and the cartons are then preferably stacked to onto a pallet. This individual package containing a nested arrangement of snack pieces that have a dip containment region (8), wherein greater than about 40% of snack pieces by weight in the package, have a containment volume greater than about 7200 mm³ is then provided or delivered to the consumer with a CV of less than about 40% and greater than about 80% of snack pieces by weight in the package have a containment volume greater than about 3600 mm³ is then provided or delivered to the consumer with a CV of less than about 35%, preferably less than about 30%.

### Package

The nested snack pieces can be packaged in a variety of packages including but not limited to canisters, trays, bags, cartons, flow wrap, sleeves, and tubs. The packaging can be oriented or displayed in either a horizontal or vertical presentation. Packaging materials can be selected from a variety of known materials including but not limited to fiber composite material, plastic materials as set forth herein, such as polyethylene (PE), polypropylene (PP), polyethylene terephthalate (PET), preferably high density polyethylene (HDPE), polypropylene or any combination thereof. Such plastic packages may be multiple layer high barrier laminate structures. Packaging materials preferably provide increased shelf stability by limiting the transfer of oxygen and moisture to the product.

Plastic snack packaging offers shape flexibility, fewer components, increased product protection and the opportunity to be lower in cost. One embodiments of the package is a mono-layer or multi-layer plastic semi-rigid, preferably rigid wall, container including a nested arrangement of snack pieces, including but not limited to single curved or compound curved potato chips or crisps, corn-based snack pieces, tortilla chips, etc.

This container can be any shape or size, including but not limited to cylindrical, triangular, polygonal, etc., having a cross section of any shape and size, including but not limited to circular, oval, triangular, square, rectangular, polygonal or any other shape.

As set forth above, when the cross sectional shape and size of the package substantially matches the cross sectional shape and size of the snack piece, it provides motion control of the snack pieces contained within the package and reduced package volume. The reduced package volume translates into higher package bulk density, i.e., more net weight of product per volume of package. This provides greater distribution efficiency, store shelf space efficiency, consumer shelf space efficiency and portability. Because the package is manufactured from plastic, the package itself can be formed into non-traditional shapes. Such shapes can be formed to communicate the shape or type of product contained within the package.

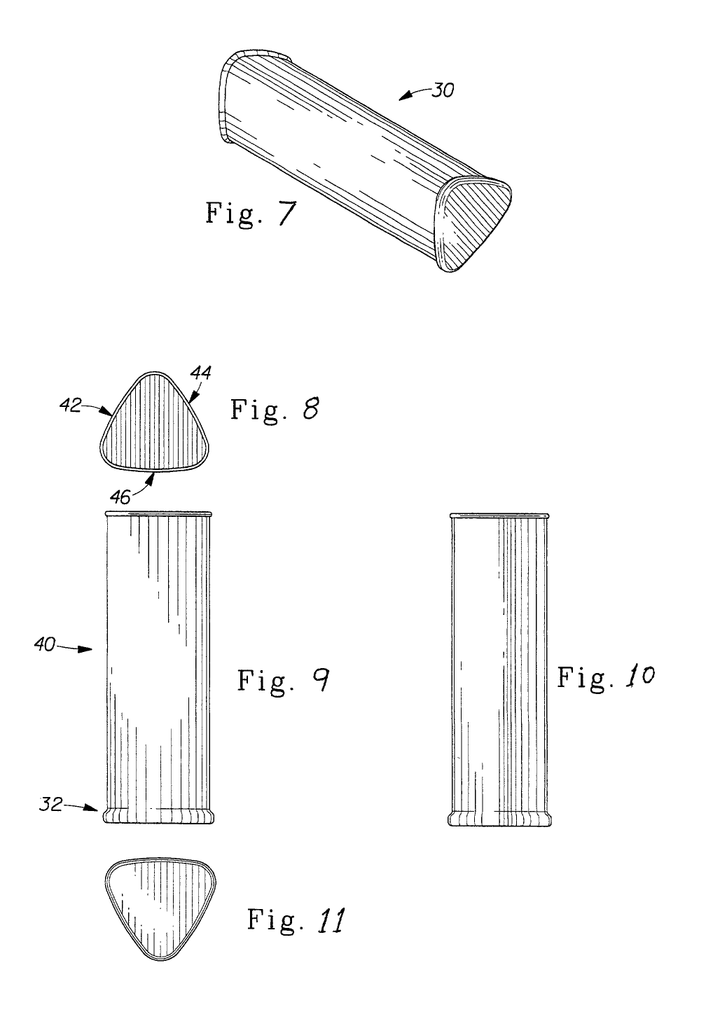

The Package size can vary greatly but is preferably in the range from about 5 to about 100 fluid ounces, more preferably about 5 to about 50 fluid ounces. The package's dimensions will and can vary greatly depending upon the desired package size/portion and the shape of the snack pieces. In a preferred embodiment, the package is shaped to substantially match the shape of the snack piece contained within the package, such as a triangular can holding a nested arrangement of similarly shaped triangular snack pieces. In the preferred embodiment as shown in FIGS. 7 through 11, the canister package is about 45 fluid ounces and has a can height of about 9.5 inches. The can (30) has a base area (32) having a height of about 1 inch and the length of each triangle leg (34), (36) and (38) in this area is about 3.2 inches. The body area (40) of the triangle can has a height of about 8.5 inches and the length of each triangle leg (42), (44) and (46) in this area is about 2.8 inches. Further, for the purposes of collating two or more cans for sale as a dual or multi-pack, one can flow wrap two cans inside a plastic bag, mold two cans together, use a single overcap to hold two or more cans, use a tray-like holding device or use a cardboard or plastic sleeve.

What is claimed is:

1. A plurality of overlapping snack pieces comprising:
a. a non-planar snack piece having a surface including random surface features extending from said surface;
b. wherein said plurality of overlapping snack pieces have a volumetric bulk density of greater than about 8.0×10⁻⁵ g/mm³.

2. A plurality of overlapping snack pieces according to claim 1, wherein said plurality of overlapping snack pieces are in a nested arrangement.

3. A plurality of overlapping snack pieces according to claim 1, wherein said volumetric bulk density is from about 8.0×10⁻⁵ g/mm³ to about 80×10⁻⁵ g/mm³.

4. A plurality of overlapping snack pieces according to claim 1, wherein said snack piece has a concave curvature.

5. A plurality of overlapping snack pieces according to claim 4, wherein said snack piece has a bowl-shaped curvature.

6. A plurality of overlapping snack pieces according to claim 1, wherein said body a segment of a sphere cap.

7. A plurality of overlapping snack pieces according to claim 5, wherein said snack piece has a radius of curvature from about 5 mm to about 500 mm.

8. A plurality of overlapping snack pieces according to claim 1, wherein said snack piece has a modulus of elasticity from about 0.1 g/mm² to about 6.0 g/mm².

9. A plurality of overlapping snack pieces according to claim 2, wherein said snack piece having a maximum thickness from about 2.5 mm to about 5.5 mm.

10. A plurality of overlapping snack pieces according to claim 1, wherein said snack piece contains a lipid content from about 18% to about 40%.

11. A plurality of overlapping snack pieces according to claim 1, wherein said snack piece has a density from about 1.0×10⁻⁴ g/mm³ to about 17×10⁻⁴ g/mm³.

12. A plurality of overlapping snack pieces according to claim 1, wherein each of said snack pieces in said plurality of overlapping snack pieces are consistent in size and shape.

13. A plurality of overlapping snack pieces according to claim 1, wherein said snack piece is contained in a package.

14. A plurality of overlapping snack pieces according to claim 14, wherein said plurality of overlapping snack pieces is placed in a package, said package having a packed bulk density from about 10×10⁻⁵ g/mm³ to about 35×10⁻⁵ g/mm³.

15. A plurality of overlapping snack pieces comprising:
a. a non-planar snack piece has a concave curvature;
b. wherein said plurality of overlapping snack pieces have a volumetric bulk density of greater than about 8.0×10⁻⁵ g/mm³.

16. A plurality of overlapping snack pieces according to claim 16, wherein said snack piece has a bowl-shaped curvature.

17. A plurality of overlapping snack pieces according to claim 16, wherein said snack piece is a segment from a sphere cap.

18. A plurality of overlapping snack pieces according to claim 16, wherein said volumetric bulk density is from about 8.0×10⁻⁵ g/mm³ to about 80×10⁻⁵ g/mm³.

19. A plurality of overlapping snack pieces according to claim 16, wherein said snack piece having a lipid content from about 18% to about 40%.

20. A plurality of overlapping snack pieces according to claim 16, wherein said plurality of overlapping snack pieces is placed in a package, said package having a packed bulk density from about 10×10⁻⁵ g/mm³ to about 35×10⁻⁵ g/mm³.

21. A plurality of overlapping snack pieces comprising:
a. a non-planar snack piece having a maximum thickness greater than about 2.5 mm;
b. wherein said plurality of overlapping snack pieces have a volumetric bulk density of greater than about 8.0×10⁻⁵ g/mm³.

22. A plurality of overlapping snack pieces according to claim 22, wherein said snack piece having a lipid content from about 18% to about 40%.

23. A plurality of overlapping snack pieces comprising:
a. a non-planar snack piece having a concave curvature;
b. wherein said plurality of overlapping snack pieces is placed in a package, said package having a packed volumetric bulk density greater than about 10×10⁻⁵ g/mm³ to about 35×10⁻⁵ g/mm³.

24. A plurality of overlapping snack pieces comprising:
a. a non-planar snack piece having a surface including random surface features extending from said surface;
b. wherein said plurality of overlapping snack pieces have a linear bulk density of greater than about 0.4 g/mm³.

25. A plurality of overlapping snack pieces according to claim 25, wherein said snack piece has a concave curvature.

26. A plurality of overlapping snack pieces according to claim 26, wherein said snack piece has a bowl-shaped curvature.

27. A plurality of overlapping snack pieces according to claim 27, wherein said body a segment of a sphere cap.

28. A plurality of overlapping snack pieces comprising:
a. a snack piece having a lipid content of less than about 23% by weight of the snack piece;
b. wherein said plurality of overlapping snack pieces have a volumetric bulk density from about 8.0×10⁻⁵ g/mm³ to about 80×10⁻⁵ g/mm³.

29. A plurality of overlapping snack pieces according to claim 29, wherein said plurality of overlapping snack pieces is placed in a package, said package having a packed volumetric bulk density from about 10×10⁻⁵ g/mm³ to about 35×10⁻⁵ g/mm³.

30. A method for making a high bulk density plurality of overlapping thick snack pieces, said method comprising the steps of:
a. controlling the radius of curvature of the chip by placing a dough piece of said snack piece adjacent to predetermined curved restraining device having a radius of curvature from 5 mm to about 500 mm;
b. cooking said dough piece while said dough piece is restrained by said curved restraining device until said dough piece transforms into said final snack piece having a surface wherein random surface features extend from said surface; and
c. placing said snack piece adjacent to other of said snack pieces to form said plurality of overlapping snack pieces, wherein said plurality of overlapping snack pieces having a volumetric bulk density greater than 8.0×10⁻⁵ g/mm³.
